(19) United States
(12) Patent Application Publication
(10) Pub. No.: US 2008/0132290 A1
(43) Pub. Date: Jun. 5, 2008

(54) METHODS AND DEVICES FOR ENVIRONMENTAL TRIGGERING OF MISSED MESSAGE ALERTS

(75) Inventors: IFTACH SHARABI, TEL AVIV (IL); YECHIEL COHEN, REHOVOT (IL); DEKEL PELED, RINATYA (IL)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/565,094

(22) Filed: Nov. 30, 2006

(51) Int. Cl. H04B 1/38

(52) U.S. Cl. 455/567; 381/56; 381/57

(57) ABSTRACT

Described are methods and devices for receiving a missed message signal, detecting an ambient noise level, determining whether the ambient noise level is at least at a predetermined ambient noise threshold value based on the detected ambient noise level. When the ambient noise level is determined to be at least at a predetermined ambient noise threshold value the methods and devices include processing missed message alert data of the missed message signal for annunciation of missed message alert data. Processing can include storing the missed message alert data to wait for the ambient noise level to be low enough so that an annunciation of the missed message is audible over the ambient noise. Annunciation of a message alert can be, for example, by audio signal output when the ambient noise is low enough that the alert may be heard by the user.

### FIELD

Disclosed are methods and communication devices for annunciating of missed message alerts, and more particularly for annunciating of missed message alerts according to detection of environmental conditions.

### BACKGROUND

Mobile communication devices, such as cellular telephones, are transported to different locations by their users. In many locations, an incoming communication alert may be audible over the ambient noise. However, there are other locations where an incoming communication alert may not be audible over the ambient noise. For example, in an office building an incoming communication alert is most likely audible. In contrast, on a street having substantial automobile traffic, an incoming communication alert may not be audible over the ambient noise.

To overcome ambient noise for an incoming communication alert, various schemes have been used. For example, increasing the volume of a call annunciator may overcome ambient noise. However, adding additional sound to the ambient noise may not be desirable or actually audible, in particular depending upon the distance between the user and the device. Also, in the event that the ambient noise is persistent, receiving a voice communication while ambient noise is high and attempting to carry on the communication may not be practical since voice communication may be difficult when ambient noise is high.

### BRIEF DESCRIPTION OF THE DRAWINGS

FIG. 1 depicts a mobile communication device according to an embodiment, that can deliver a missed message alert signal once ambient noise is reduced;

FIG. 2 shows a flow chart according to an embodiment, illustrating that a mobile communication device can deliver a missed message alert signal once ambient noise is reduced;

FIG. 3 shows a flowchart that illustrates a method according to an embodiment in which when detecting an ambient noise level, a determination can be made as to whether a message alert has been accessed or acknowledged within a predetermined period of time;

FIG. 4 illustrates a method for adjusting the microphone gain or annunciating the ambient and/or environmental noise levels according to an embodiment; and

FIG. 5 illustrates a method according to an embodiment for annunciating a suitability message to indicate the suitability of the communication environment.

### DETAILED DESCRIPTION

In a noisy environment an audio signal such as a ring tone to indicate an incoming communication may not be heard by a user if the device's currently selected ringer volume control for the ringtone is lower than the ambient noise. If an incoming communication is not answered or accessed by the user, the device generally generates an otherwise audible missed call alert signal that ends after a predetermined period of time. However, in the noisy environment, an audio signal for a missed call alert may not be heard by the user and thus the user will not be alerted to the missed call. It may be beneficial for the device to postpone generating a missed call alert signal at least until the first quiet period after the missed call. By waiting until the ambient or environmental noise is reduced, an audio alert can become audible to a user. Since the user can benefit from the first quiet period and can be alerted to the missed message alert as soon as it is audible above the ambient noise, a user need not check the display device of the device for missed messages while or after being in a noisy environment. Additionally, it may be beneficial to wait until the ambient noise level of a noisy environment is reduced to carry on a voice communication.

Described are methods and devices for receiving a missed message signal, detecting an ambient noise level, determining whether the ambient noise level is at least at a predetermined ambient noise threshold value based on the detected ambient noise level. When the ambient noise level is determined to be at least at a predetermined ambient noise threshold value the methods and devices include processing missed message alert data of the missed message signal for annunciation of missed message alert data. Processing can include storing the missed message alert data to wait for the ambient noise level to be low enough so that an annunciation of the missed message is audible over the ambient noise. Annunciation of a message alert can be, for example, by audio signal output when the ambient noise is low enough that the alert may be heard by the user.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

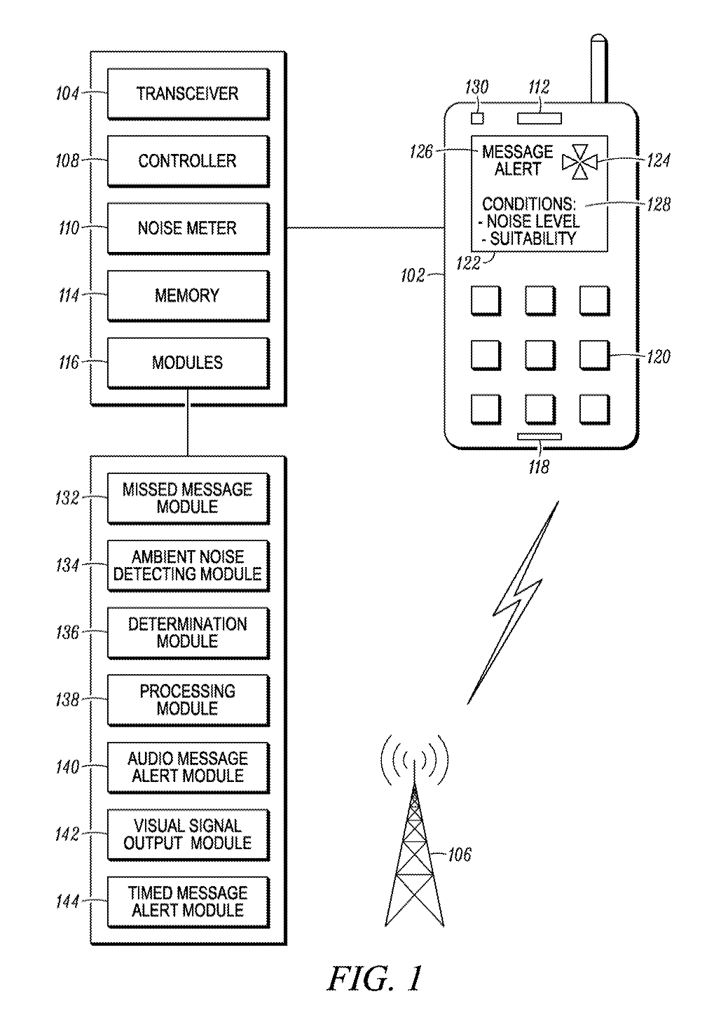

FIG. 1 depicts a mobile communication device that can deliver a missed message alert signal once ambient noise is reduced according to an embodiment. Additionally, FIG. 1 depicts a mobile communication device that can provide indicia to signal when an ambient noise level of a noisy environment, or other conditions, are reduced to a level sufficiently low to carry on a voice communication. The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The mobile communication device 102 can receive and transmit communication by one or more transceivers 104 via a network provider 106, phone to phone, or in any transmission manner. FIG. 1 depicts a network provider that may be coupled to a server to receive and transmit communication. The network provider 106 of course may use any type of wireless network including an ad hoc or wireless personal area network, a WiFi or wireless local area network, and a cellular or wireless wide area network. Likewise, the server may be of any suitable configuration. The server may be implemented as a single server or as a plurality of servers in communication in any arrangement. The operations of the server may be distributed among different servers or devices that may communicate in any manner. It is understood that the depiction in FIG. 1 is for illustrative purposes.

The network provider 106 may transmit a communication such as a voice communication signal to the mobile communication device 102, however, the user of the device 102 may not answer the call. In that event, the network provider 106 may send a missed call alert signal to the mobile communication device 102, for example, once a message is left in voice mail. Alternatively, the missed message signal can be generated by the mobile communication device. In another situation, the network provider 106 may transmit a communication such as an SMS message signal to the mobile communication device 102. However, the user of the device 102 may not acknowledge receipt of the communication. In that event, the service provider 106 may send a missed SMS message alert signal to the mobile communication device 102. It is understood that a missed call, a voice mail message, SMS message, pushed communication or any other form of received communication by the mobile communication device 102 is within the scope of the term “missed message” as used below.

The mobile communication device 102 can further include a processor or controller 108 configured to carry out instructions, a noise meter 110 coupled to the controller 108 and configured to determine an ambient noise level, a speaker 112 coupled to the controller 108 and configured to provide audio output, a memory 114 coupled to the controller 108 and configured to store modules and missed message signal data, and a transceiver 104 coupled to the controller 108 and configured to receive a missed message and missed message alert data as mentioned above. The device can further include a microphone 118, a keypad 120 and a display 122.

In FIG. 1, shown on the display 122 are a symbol indicator 124 and a written indicator 126 of a missed message alert that may be displayed after a missed communication. Also illustrated is an indicator 128 for ambient and/or environmental conditions, such as noise level and suitability for communication. Additionally, a visual signal output device 130 can provide a missed message indication or alert. Visual signal output device 130 can be, for example, an LED.

The mobile communication device 102 may further include modules 116 including instructions. The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The modules can include a missed message module 132 including instructions for receiving a missed message signal via the transceiver 104, an ambient noise detecting module 134 including instructions for detecting an ambient noise level by a noise meter 110, a determination module 136 including instructions for determining whether the ambient noise level is at least at a predetermined ambient noise threshold value and a processing module 138 including instructions for processing missed message alert data when the ambient noise level is determined to be at least at a predetermined ambient noise threshold value. The modules can further include an audio message alert module 140 coupled to the speaker 112 for annunciating a message alert based on the missed message alert data by audio output. Additionally, the modules can include a visual signal output message alert module 142 for annunciating a message alert based on the missed message alert data by a visual signal output device such as display 122 and/or device 130. Moreover, the modules can include a timed message alert module 144 coupled to the speaker 112 for adjusting the volume of a message alert after a predetermined period of time.

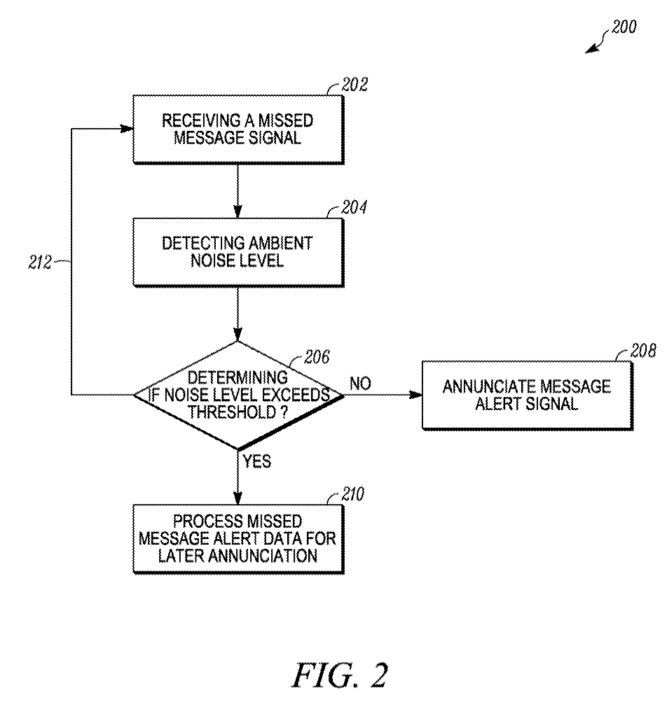

FIG. 2 shows a flow chart according to an embodiment, illustrating that a mobile communication device can deliver a missed message alert signal once ambient noise is reduced. The method 200 includes receiving a missed message signal 202. When the user initially does not accept or access a communication, a missed message signal may be transmitted to the device. A flag may be raised in software to log a missed communication and store it in memory 114 (see FIG. 1) so that the device can process a missed message alert when the ambient noise is reduced or ceases.

As mentioned above, the missed message signal can be from any source and can be of any type. Alternatively, the missed message signal can be generated by the mobile communication device. In any event, the method includes detecting an ambient noise level 204 as mentioned above by a noise meter 110 (see FIG. 1) coupled to the controller 108 and configured to determine an ambient noise level. The noise meter may be an independent component. Alternatively, the mobile communication device's digital signal processing (DSP) capability may include the ability to measure outside noise levels. It is understood that any suitable noise meter that can detect ambient noise can be utilized.

As mentioned above, a ringer volume for the ringtone of the mobile communication device can be pre-selected by a user or can be a default setting. Ringtones are available in variety. If a user is often in a noisy environment, the ringtone may be set to overcome the ambient noise. In any case, the volume of the ringtone may be overcome by ambient noise that prevents a user from hearing the ring. When the detected ambient noise would make the ringtone inaudible, a software flag can be raised as described above to alert the user of the missed call as the noise descends so that a ring may be audible. Determining whether the ambient noise level meets or exceeds a predetermined ambient noise threshold value 206 based on the detected ambient noise level either can result in annunciating the missed message alert 208 or can result in processing the missed message alert data for later annunciation 210.

Processing of the missed message alert data of the missed message signal can continue until annunciation of missed message alert data when the ambient noise level is determined to fall to, or fall below, a predetermined ambient noise threshold value. In one embodiment, the missed message alert data can continue to be stored while the noise meter detects the ambient noise level 204. The loop 212 illustrates that the real-time processing of the missed message alert data may continue until it is determined that the ambient noise level 206 has declined so that the ring may be audible, before annunciating a message alert signal 208. Accordingly, the mobile communication device 102 can deliver a missed message alert signal once ambient noise is reduced.

In another embodiment, when a delayed missed message alert is generated, a mobile communication device may prompt a user to acknowledge a missed message alert. A prompt to acknowledge a missed message alert may be provided, for example by indicia on the display 122 (see FIG. 1) or by audio output of the speaker 112. The device 102 can continue to store missed message alert data in memory when it is determined that an annunciated missed message alert data has not been accessed within a predetermined period of time. In a noisy environment, it may be that the user may not have heard the alert even though the noise level has dropped. If not acknowledged, the missed message alert can be repeated.

In another embodiment, if ambient noise persists at varying levels and the missed message alert is not acknowledged, then the alert can be repeated. The level of the ambient noise may decrease only temporarily and then may increase past its previous level. It is understood that changes in the ambient noise level that are increasing and decreasing may provide options for varying alerting configurations. Adjustments of the ambient noise threshold value may be made in real-time. Ambient noise may be very loud, in which case an adjustment of the volume of the message alert so that it can be heard by the user may be futile. There may be an amplitude of ambient noise at which an adjustment of the ambient noise threshold value and the volume of the message alert may be effective. A real-time calculation to make such a determination can be made so that the volume of the message alert may be raised or lowered in such a situation.

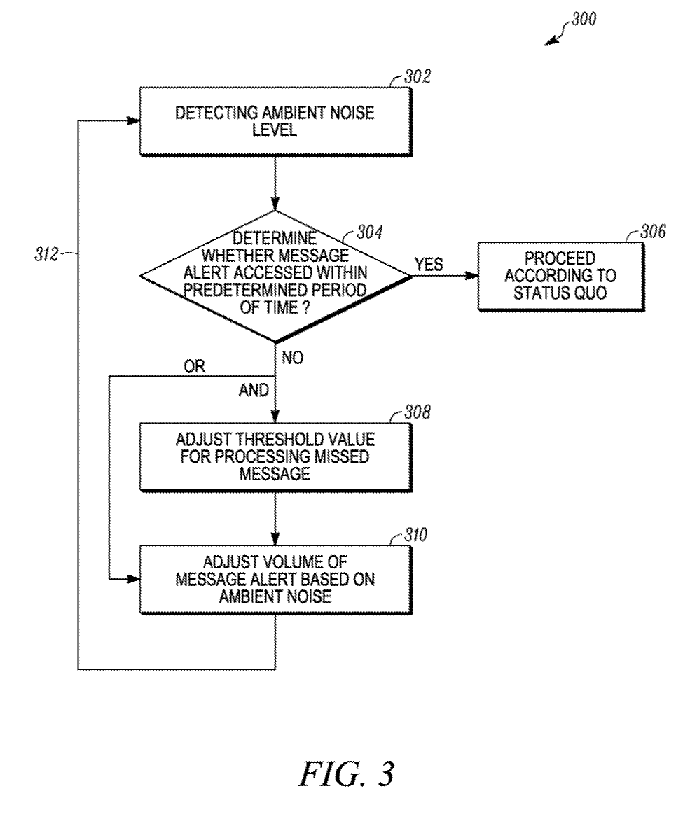

Turning to FIG. 3, a flowchart illustrates a method 300 that when detecting the ambient noise level 302 a determination can be made as to whether a message alert has been accessed or acknowledged within a predetermined period of time 304. If the alert has been accessed or acknowledged, then the device can return to the status quo 306 which, for example, may be awaiting the next communication. If it is determined that the message alert has not been accessed, then the threshold value for processing missed message signals can be adjusted 308, particularly if a predetermined period of time has elapsed since the missed message alert. Additionally or alternatively, there may be an adjustment in the missed message alert volume and/or visual signal based on the ambient noise 310. The real-time processing loop 312 indicates that upon adjustments, the detecting process 302 can be repeated or continued.

Preferences as to whether to repeat a missed message alert or prompt for acknowledgement can be set by the user or may be set by default settings. Moreover, preferences can be set as to whether to repeat a missed message alert at varying volumes that can be set by the user when considering the circumstances of expected ambient noise. Furthermore, preferences as to whether to adjust the threshold value in real-time may also be available to the user or may be a default setting.

Again referring to FIG. 2, there are different manners in which to annunciate a message alert 208 based on the missed message alert data when the ambient noise level is below a predetermined ambient noise threshold value and/or would not be audible over currently detected ambient noise. As mentioned, the device may update the threshold value based on changes in the ambient noise level so that message alert may be annunciated based on the missed message alert data when it is determined that the ambient noise level is below a previously determined ambient noise level. Annunciation of a message alert may be by audio signal output of the speaker 112 on the mobile communication device, or remote to the mobile communication device such as a Bluetooth device. Annunciation of a message alert 124, 126 may be by visual signal output of the display 122, by another indicator on the device that can be brighter than the display 130 or by another visual signal output device remote to the mobile communication device such as a Bluetooth device.

As described above, when the mobile communication device 102 detects noise louder that a preset level and upon a missed call that is received while it is noisy, it can raise a flag to alert, possibly with a special ringtone, just as the noise level descends so that the ringtone is audible to the user which may be at a preset threshold level. That is, the device can wait until the ambient or environmental noise is reduced to benefit from this instant to alert the user of any missed calls during the period where the user has been unable to notice incoming calls.

It may be beneficial to wait until the ambient noise level of a noisy environment is reduced to carry on a voice communication. To overcome the ambient noise level during a communication, the microphone's 118 (see FIG. 1) gain may be adjusted. Moreover, the output of the speaker 112 may be adjusted according to safety guidelines. Noise and other unsuitable conditions may make carrying on a voice communication difficult for a user. A conditions suitability indicator 126 may annunciate to the user the suitability of the ambient conditions for communication.

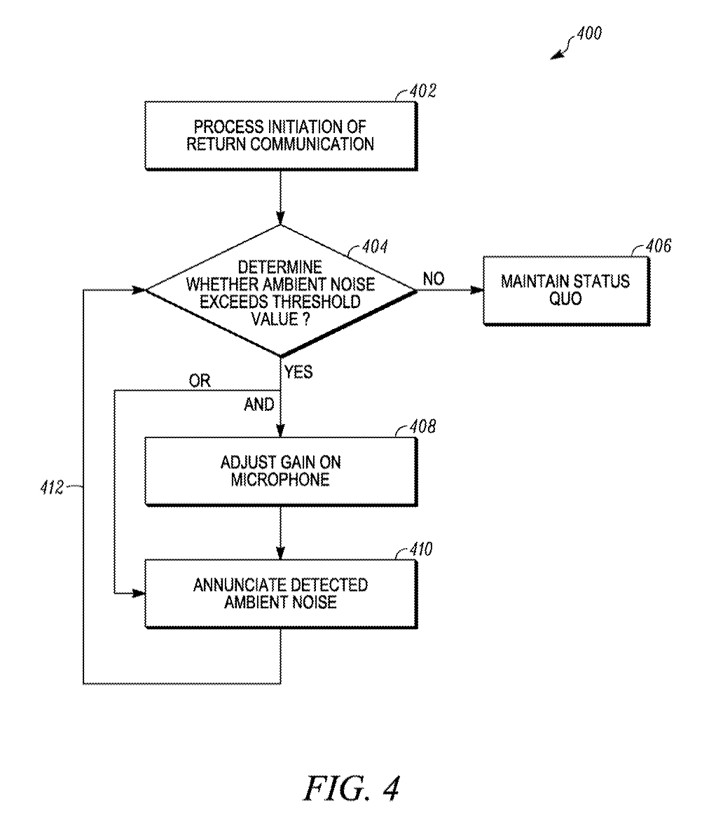

FIG. 4 illustrates a method 400 for adjusting the microphone gain or annunciating the ambient and/or environmental noise levels according to an embodiment. The method 400 includes processing the initiation of a communication based on the message alert 402 and determining whether the ambient noise level during the communication is at least at a predetermined communication ambient noise threshold value 404 based on the detected ambient noise level. If the ambient noise level is less than a noise level threshold then it may or may not be indicated 406. In the event that it is at or above the noise level threshold, then the gain of the microphone can be adjusted 408 based on the detected ambient noise level during a communication. Also, in the event that the noise level is detected at or above a noise level threshold, then the noise level may be annunciated or otherwise indicated 410. Annunciating the detected ambient noise level 410 includes generating an audio signal during the communication to overcome ambient noise. As mentioned above, a condition indicator 128 (see FIG. 1) including a noise level indicator is shown on display 122. A loop 412 is shown to indicate that the detection and information feedback can be processed in real-time.

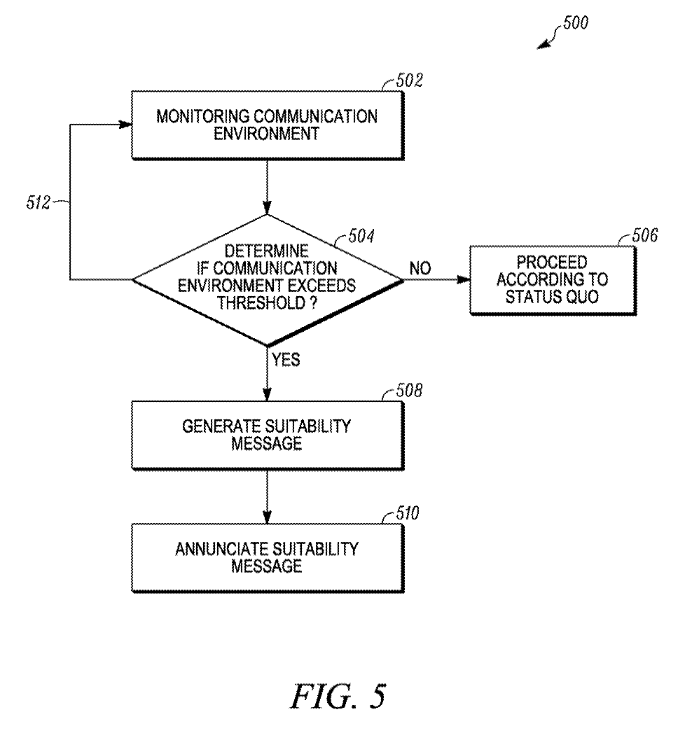

As mentioned above, a conditions suitability indicator 128 shown on display 122 may annunciate to the user the suitability of the ambient conditions for communication. The suitability of the communication environment is based on at least one of ambient noise level, atmospheric conditions, a state of motion of the mobile communication device or any other environment condition. FIG. 5 illustrates a method 500 for annunciating a suitability message to indicate the suitability of the communication environment according to an embodiment. Method 500 includes monitoring 502 to determine 504 the suitability of the communication environment and generating a suitability message signal based on the monitored suitability of the communication environment. If the suitability conditions are normal then it may or may not be indicated 506. The method further includes generating 508 and annunciating 510 a suitability message to indicate the suitability of the communication environment. Annunciating can include displaying a suitability message 128 and/or generating an audio signal from the speaker 112 to indicate the suitability of the communication environment.

As described above, in a noisy environment a ring tone may not be heard by a user. The device or network provider generally generates an otherwise audible missed call alert signal. However, in the noisy environment, an audio signal for a missed call alert may also not be heard by the user and thus the user will not be alerted to the missed call. Also described above, it may be beneficial for the device to wait until the ambient or environmental noise is reduced to generate a missed call alert signal during the first quiet period, and in particular an audio alert so that the audio alert can be audible to a user. Thus, the user can benefit from one or more quiet periods and can be alerted to the missed message alert as soon as it is audible above the ambient noise. Accordingly, a user need not check the display 122 of the device 102 for missed messages while or after being in a noisy environment.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method in a mobile communication device, the method comprising:
receiving a missed message signal;
detecting an ambient noise level;
determining whether the ambient noise level is at least at a predetermined ambient noise threshold value based on the detected ambient noise level; and
processing missed message alert data of the missed message signal for annunciation of missed message alert data when the ambient noise level is determined to be at least at a predetermined ambient noise threshold value.

2. The method of claim 1 wherein processing comprises:
storing the missed message alert data when the ambient noise level is determined to be at least at a predetermined ambient noise threshold value.

3. The method of claim 1, further comprising:
annunciating a message alert based on the missed message alert data when the ambient noise level is less than a predetermined ambient noise threshold value.

4. The method of claim 1, further comprising:
annunciating a message alert based on the missed message alert data when it is determined that the ambient noise level is below a previously determined ambient noise level.

5. The method of claim 1 wherein annunciation is a message alert comprises:
annunciating by audio signal output.

6. The method of claim 1, wherein annunciation is a message alert comprises:
annunciating by visual signal output.

7. The method of claim 1, wherein the mobile communication device includes a speaker having an adjustable volume, the method further comprising:
adjusting the ambient noise threshold value for processing a missed message alert based on the ambient noise.

8. The method of claim 1, wherein the mobile communication device has a communication environment, and wherein the communication environment has a suitability for communication, the method further comprising:
monitoring the suitability of the communication environment;
generating a suitability message signal based on the monitored suitability of the communication environment; and
annunciating a suitability message to indicate the suitability of the communication environment.

9. The method of claim 8, wherein the suitability of the communication environment is based on at least one of ambient noise level, atmospheric conditions, and a state of motion of the mobile communication device.

10. The method of claim 8, wherein annunciating the suitability message comprises at least one of displaying a suitability message and generating an audio signal to indicate the suitability of the communication environment.

11. The method of claim 1, wherein the mobile communication device includes a microphone having an adjustable gain, the method further comprising:
processing the initiation of a communication based on the message alert;
determining whether the ambient noise level during the communication is at least at a predetermined call ambient noise threshold value based on the detected ambient noise level; and
adjusting the gain of the microphone based on the detected ambient noise level during a communication.

12. The method of claim 1, further comprising:
processing the initiation of a communication based on the message alert;
determining whether the ambient noise level during the communication is at least at a predetermined communication ambient noise threshold value based on the detected ambient noise level; and
annunciating the detected ambient noise level when the detected ambient noise level is least at the predetermined communication ambient noise threshold value.

13. The method of claim 11 wherein annunciating the detected ambient noise level includes generating an audio signal during the communication to overcome ambient noise.

14. A method in a mobile communication device, comprising:
receiving a missed message signal;
detecting ambient noise level;
determining whether the ambient noise level is at least at a predetermined ambient noise threshold value based on the detected ambient noise level;
processing missed message alert data when the ambient noise level is determined to be at least at a predetermined ambient noise threshold value;
determining the currently detected ambient noise; and
annunciating a message alert based on the missed message alert data when it is determined an annunciated message alert is audible over currently detected ambient noise.

15. The method of claim 14, wherein the mobile communication device includes a speaker having an adjustable volume and wherein annunciating a message alert comprises:
adjusting the volume of the message alert based on the ambient noise.

16. The method of claim 14, further comprising:
determining whether the missed message alert data has been accessed;
continuing to store missed message alert data when it is determined that an annunciated missed message alert data has not be accessed within a predetermined period of time; and
annunciating a message alert based on the missed message alert data when it is determined an annunciated message alert is audible over currently detected ambient noise.

17. A mobile communication device, comprising:
a controller configured to carry out instructions;
a noise meter coupled to the controller configured to determine an ambient noise level;
a speaker coupled to the controller configured to provide audio output;
a memory coupled to the controller configured to store modules and missed message signal data;
a transceiver coupled to the controller configured to receive missed message signals;
a missed message module including instructions for receiving a missed message signal via the transceiver;
an ambient noise detecting module including instructions for detecting ambient noise level by a noise meter;
a determination module including instructions for determining whether the ambient noise level is at least at a predetermined ambient noise threshold value based on the detected ambient noise level; and
a processing module including instructions for processing missed message alert data when the ambient noise level is determined to be at least at a predetermined ambient noise threshold value.

18. The device of claim 17, further comprising:
an audio message alert module coupled to the speaker for annunciating a message alert based on the missed message alert data by audio output.

19. The device of claim 17, further comprising:
a visual signal output message alert module for annunciating a message alert based on the missed message alert data by visual signal output.

20. The method of claim 17, further comprising:
a timed message alert module coupled to the speaker for adjusting the volume of a message alert based on the missed message alert data when it is determined that an annunciated message alert is audible over currently detected ambient noise after a predetermined period of time.
